(19) United States
(12) Patent Application Publication
(10) Pub. No.: US 2022/0052871 A1
(43) Pub. Date: Feb. 17, 2022

(54) VEHICLE CONTROL SYSTEM, VEHICLE CONTROL METHOD, AND NON-TRANSITORY COMPUTER-READABLE MEDIUM IN WHICH VEHICLE CONTROL PROGRAM IS STORED

(71) Applicant: NEC Corporation, Minato-ku, Tokyo (JP)

(72) Inventor: Ryuji NAKAJIMA, Tokyo (JP)

(73) Assignee: NEC Corporation, Minato-ku, Tokyo (JP)

(21) Appl. No.: 17/435,783

(22) PCT Filed: Jan. 28, 2020
(86) PCT No.: PCT/JP2020/002957

§ 371 Date: Sep. 2, 2021

(30) Foreign Application Priority Data
Mar. 13, 2019 (JP) 2019-046463

(51) Int. Cl. H04L 12/40; G07C 5/00

(52) U.S. Cl. CPC H04L 12/40; H04L 2012/40273; G07C 5/008

(57) ABSTRACT

The present invention provides a vehicle control system, a vehicle control method, and a vehicle control program that are capable of changing a physical ECU to be assigned to a vehicle function. A plurality of physical ECUs control operation of a device installed in a vehicle. A plurality of bus virtualization devices respectively control communications of the plurality of physical ECUs. In order to configure one or more logical ECUs that perform communications only between physical ECUs selected from the plurality of physical ECUs, a control unit (1) controls bus virtualization devices corresponding to the selected physical ECUs.

### TECHNICAL FIELD

The present invention relates to a vehicle control system, a vehicle control method, and a vehicle control program.

### BACKGROUND ART

In a vehicle such as an automobile, operation of an engine or other units is controlled by a vehicle control system including an Electronic Control Unit (ECU). In such a vehicle control system, a plurality of function blocks are provided (Patent Literature 1). In this example, the function blocks are implemented in ECUs and the ECUs are distributed in a plurality of areas in which an in-vehicle device is installed. Also, the function blocks are classified into a plurality of domains. This makes it possible to identify an area and a domain in which a function block is to operate.

As a method for causing the plurality of function blocks to operate, a multi-core processor control method has been proposed (Patent Literatures 2 and 3, Non Patent Literature 1). In this example, a local scheduler provided for each of a plurality of cores causes a thread assigned to the home core to be executed in accordance with its priority. A global scheduler that determines an operation core for a thread to be generated determines execution of thread migration between the plurality of cores based on a predetermined scheduling policy. N threads having higher priorities among threads assigned to the cores are controlled to be excluded from the thread migration. According to the cited literatures, the above processing implements an SMP (Symmetric Multiprocessing) model in a multi-core processor to improve the throughput as well as guarantees an execution time of a thread having a high priority to provide real-time property.

### CITATION LIST

### Patent Literature

Patent Literature 1: Japanese Unexamined Patent Application Publication No. 2018-70132
Patent Literature 2: Japanese Unexamined Patent Application Publication No. 2014-96024
Patent Literature 3: Japanese Unexamined Patent Application Publication No. 2015-164052

### Non Patent Literature

Non Patent Literature 1: “Scalable real-time OS compatible with many-core processors”, searched on Feb. 27, 2019; URL:
   https://www.esol.co.jp/embedded/emcos.html

### SUMMARY OF INVENTION

### Technical Problem

An ECU used in a vehicle such as an automobile has an installation location in a vehicle and a function that are fixed in the design process. It is thus out of expectation that the installation location or function may be changed. As a result, it is impossible to retrofit an additional ECU to expand the functions of a vehicle control system or use another ECU to provide a substitute function for an existing ECU that is malfunctioning.

The invention has been accomplished in consideration of the above circumstances and aims to provide a vehicle control system, a vehicle control method, and a vehicle control program that are capable of changing a physical ECU to be assigned to a vehicle function.

### Solution to Problem

A vehicle control system as an aspect of the invention includes: a plurality of physical ECUs that control operation of a device installed in a vehicle; a plurality of bus virtualization devices that respectively control communications of the plurality of physical ECUs; and a control unit that, in order to configure one or more logical ECUs that perform communications only between physical ECUs selected from the plurality of physical ECUs, controls a bus virtualization device corresponding to the selected physical ECUs.

A vehicle control method as an aspect of the invention includes: in order to configure one or more logical ECUs that perform communications only between physical ECUs selected from a plurality of physical ECUs that control operation of a device installed in a vehicle, selecting physical ECUs that configure the one or more logical ECUs; and controlling a plurality of bus virtualization devices, corresponding to the selected physical ECUs, that respectively control communications of the plurality of physical ECUs.

A vehicle control program as an aspect of the invention causes a computer to execute: in order to configure one or more logical ECUs that perform communications only between physical ECUs selected from a plurality of physical ECUs that control operation of a device installed in a vehicle, processing to select physical ECUs that configure the one or more logical ECU, and processing to control a plurality of bus virtualization devices, corresponding to the selected physical ECUs, that respectively control communications of the plurality of the physical ECUs.

### Advantageous Effects of Invention

According to the invention, it is possible to provide a vehicle control system, a vehicle control method, and a vehicle control program that are capable of changing a physical ECU to be assigned to a vehicle function.

### BRIEF DESCRIPTION OF THE DRAWINGS

FIG. 1 schematically illustrates a configuration of a vehicle control system according to a first example embodiment.

FIG. 2 schematically illustrates an example in-vehicle device as a control target of the vehicle control system according to the first example embodiment.

FIG. 3 schematically illustrates an example hardware configuration of a control unit according to the first example embodiment.

FIG. 4 schematically illustrates a configuration of a logical ECU according to the first example embodiment.

FIG. 5 schematically illustrates another configuration of the logical ECU according to the first example embodiment.

FIG. 6 schematically illustrates another configuration of the logical ECU according to the first example embodiment.

FIG. 7 schematically illustrates a function configuration of the logical ECU according to the first example embodiment.

FIG. 8 schematically illustrates another function configuration of the logical ECU according to the first example embodiment.

FIG. 9 schematically illustrates another function configuration of the logical ECU according to the first example embodiment.

FIG. 10 schematically illustrates a configuration of a logical ECU including an external physical ECU according to the first example embodiment.

FIG. 11 schematically illustrates a configuration of a vehicle control system according to a second example embodiment.

FIG. 12 schematically illustrates a configuration of a logical ECU according to the second example embodiment.

FIG. 13 schematically illustrates another configuration of the logical ECU according to the second example embodiment.

FIG. 14 illustrates a configuration table in a vehicle control system according to a third example embodiment.

FIG. 15 schematically illustrates a CPU core assignment table in the vehicle control system according to the third example embodiment.

FIG. 16 illustrates a flowchart of physical ECU assignment processing of a logical ECU according to the third example embodiment.

FIG. 17 illustrates a configuration table in a vehicle control system according to a fourth example embodiment.

FIG. 18 illustrates a CPU core assignment table in the vehicle control system according to the fourth example embodiment.

FIG. 19 illustrates a flowchart of physical ECU assignment processing of a logical ECU according to the fourth example embodiment.

FIG. 20 schematically illustrates a CPU core assignment table in a vehicle control system according to a fifth example embodiment.

FIG. 21 illustrates a flowchart of physical ECU assignment processing of a logical ECU according to the fifth example embodiment.

### DESCRIPTION OF EMBODIMENTS

Example embodiments of the invention will be described below with reference to the accompanying drawings. In the drawings, the same signs are given to the same elements and the duplicated description will be omitted as appropriate.

### First Example Embodiment

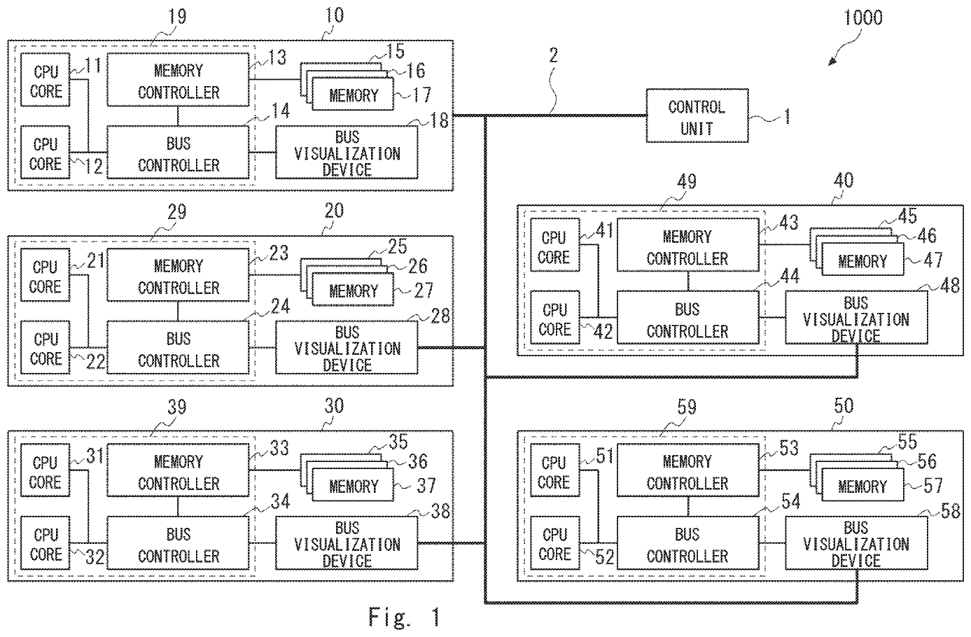

A vehicle control system according to a first example embodiment will be described. FIG. 1 schematically illustrates a configuration of a vehicle control system 1000 according to the first example embodiment. The vehicle control system 1000 according to the first example embodiment includes a plurality of physical control units (hereinafter referred to as ECUs (Electronic Control Units)), across which a virtual logical ECU is configured.

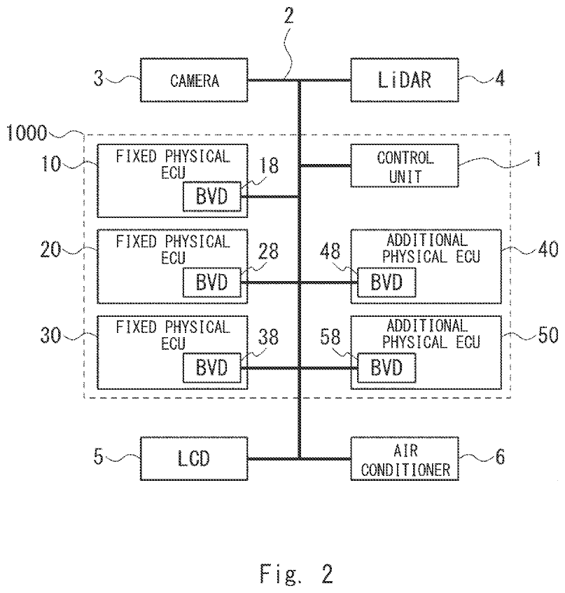

The vehicle control system 1000 is configured to control individual devices installed in a vehicle (in-vehicle devices). FIG. 2 illustrates an example in-vehicle device to be controlled by the vehicle control system 1000. This example assumes, as targets of control by the vehicle control system 1000, a camera 3, a LiDAR (Light Detection and Ranging) 4, a Liquid Crystal Display (LCD) 5 and an air conditioner 6. In FIG. 2, a bus virtualization device described later is denoted as a BVD.

Referring to FIG. 1 again, a configuration of the vehicle control system 1000 will be described. As illustrated in FIG. 1, the vehicle control system 1000 includes fixed physical ECUs 10, 20 and 30, additional physical ECUs 40 and 50, a control unit 1 and a bus 2. The fixed physical ECUs 10, 20 and 30 are physical ECUs that are permanently installed in a vehicle during manufacture of the device or the like and are not removed or re-installed after shipment of the vehicle. The additional physical ECUs 40 and 50 are physical ECUs installed in a vehicle as appropriate and can be removed or re-installed after shipment of the vehicle.

The fixed physical ECU 10 includes CPU (Central Processing Unit) cores 11 and 12, a memory controller 13, a bus controller 14, memories 15 to 17 and a bus virtualization device 18. The CPU cores 11 and 12, the memory controller 13 and the bus controller 14 may be configured as a single IC (Integrated Circuit) package 19.

The CPU (Central Processing Unit) cores 11 and 12 perform arithmetic operation in accordance with data or a program loaded from the memories 15 to 17 or the like, and configure a dual-core processor in this example.

The bus controller 14 is configured as being capable of controlling exchange of information such as data between the CPU 11, the CPU 12, the memory controller 13 and the bus virtualization device 18.

The memory controller 13 is connected to the memories 15 to 17 and is capable of outputting data or the like loaded from the memories 15 to 17 to the CPU 11 and CPU 12 or other physical ECUs via the bus controller 14. The memory controller 13 is capable of writing data or the like received from the CPU 11 and CPU 12 or other physical ECUs into the memories 15 to 17.

The memories 15 to 17 is ready for data read/write operation in accordance with an instruction from the memory controller 13. The memories 15 to 17 may use a variety of non-volatile storage devices such as a flash memory.

The bus virtualization device 18, in response to an instruction from the control unit 1, controls data exchange between an internal unit in the fixed physical ECU 10 and other ECUs.

In this example embodiment, a hardware configuration of the fixed physical ECUs 20 and 30 as well as the additional physical ECUs 40 and 50 is the same as that of the fixed physical ECU 10. In other words, CPU cores 21 and 22, a memory controller 23, a bus controller 24, memories 25 to 27 and a bus virtualization device 28 of the fixed physical ECU 20 correspond respectively to the CPU cores 11 and 12, the memory controller 13, the bus controller 14, the memories 15 to 17 and the bus virtualization device 18 of the fixed physical ECU 10. CPU cores 31 and 32, a memory controller 33, a bus controller 34, memories 35 to 37 and a bus virtualization device 38 of the fixed physical ECU 30 correspond respectively to the CPU cores 11 and 12, the memory controller 13, the bus controller 14, the memories 15 to 17 and the bus virtualization device 18 of the fixed physical ECU 10. CPU cores 41 and 42, a memory controller 43, a bus controller 44, memories 45 to 47 and a bus virtualization device 48 of the additional physical ECU 40 correspond respectively to the CPU cores 11 and 12, the memory controller 13, the bus controller 14, the memories 15 to 17 and the bus virtualization device 18 of the fixed physical ECU 10. CPU cores 51 and 52, a memory controller 53, a bus controller 54, memories 55 to 57 and a bus virtualization device 58 of the additional physical ECU 50 correspond respectively to the CPU cores 11 and 12, the memory controller 13, the bus controller 14, the memories 15 to 17 and the bus virtualization device 18 of the fixed physical ECU 10. IC packages 29, 39, 49 and 59 correspond to the IC package 19 of the fixed physical ECU 10.

Next, a configuration of a logical ECU will be described. The control unit 1 gives an instruction to the bus virtualization devices 18, 28, 38, 48 and 58 corresponding to the fixed physical ECUs 10, 20 and 30, and the additional physical ECUs 40 and 50 to logically interconnect a plurality of ECUs thereby configuring a logical ECU.

An example hardware configuration of the control unit 1 according to this example embodiment will be described. Each function of the control unit 1 is implemented by any combination of hardware and software including a CPU (Central Processing Unit), a memory, a program loaded into the memory, a storage unit, such as a hard disk, that stores the program, of any computer, as well as a program stored at the shipment of a device and a program loaded from a storage medium such as a CD (Compact Disc) and a program downloaded from a server on the Internet, and an interface for network connection. It will be apparent to those skilled in the art that its implementation method and device have a variety of variants.

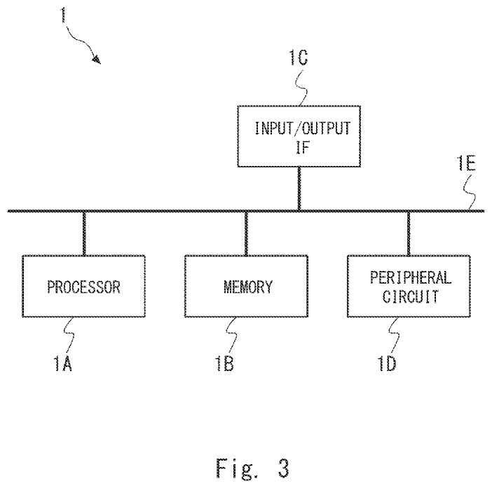

FIG. 3 schematically illustrates an example hardware configuration of the control unit 1. As illustrated in FIG. 3, an individual control unit 1 includes a processor 1A, a memory 1B, an input/output interface 1C, a peripheral circuit 1D and a bus 1E.

The processor 1A, the memory 1B, the input/output interface 1C and the peripheral circuit 1D are capable of transmitting/receiving data to/from each other via the bus 1E.

For example, the processor 1A may use a variety of arithmetic processing devices such as a CPU (Central Processing Unit) and a GPU (Graphics Processing Unit). The processor 1A can issue an instruction to each module and perform arithmetic operation based on results of arithmetic operation made by the module. For example, the memory 1B can use a variety of storage devices such as a RAM (Random Access Memory) and a ROM (Read Only Memory). The input/output interface 1C includes an interface used to acquire information from an input device such as a keyboard, a mouse or a microphone, an external device, an external server, an external sensor or the like, and an interface used to output information to an output device such as a display, a loudspeaker, a printer or a mailer, an external device, an external server or the like. The peripheral circuit 1D includes a variety of modules. The control unit 1 may not include the peripheral circuit 1D.

The control unit 1 transmits, to a physical ECU via a bus 2, a configuration instruction INS that instructs to configure a logical ECU. The configuration instruction INS includes at least an address of an instruction-target physical ECU and information to specify a target physical ECU and one or more physical ECUs that configure a logical ECU. For example, configuration instructions INS include configuration instructions INS1 to INS5 that are given to the fixed physical ECU 10, 20 or 30, or the additional physical ECU 40 or 50. This allows a bus virtualization device to virtualize an internal bus or a bus 2 of the vehicle control system 1000 to configure one or more logical ECUs. In other words, a bus virtualization device acts as a connected virtualization device to establish a logical connection relationship between physical ECUs thereby configuring a logical ECU.

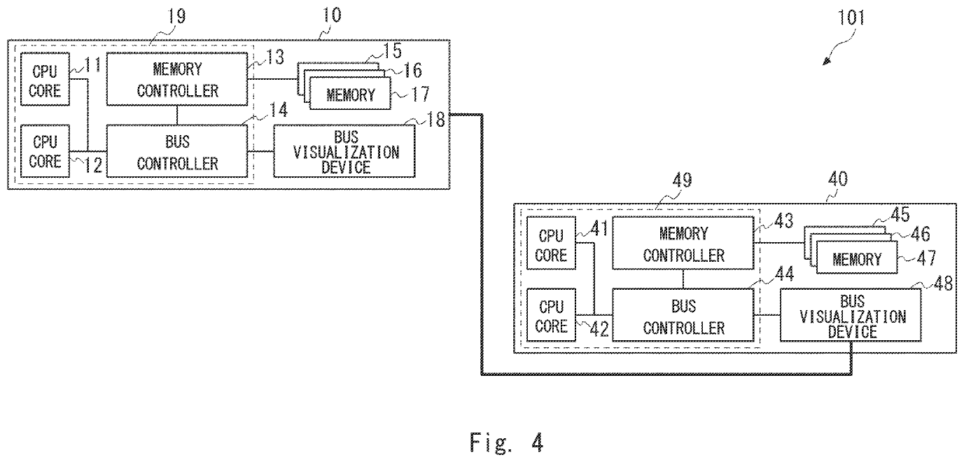

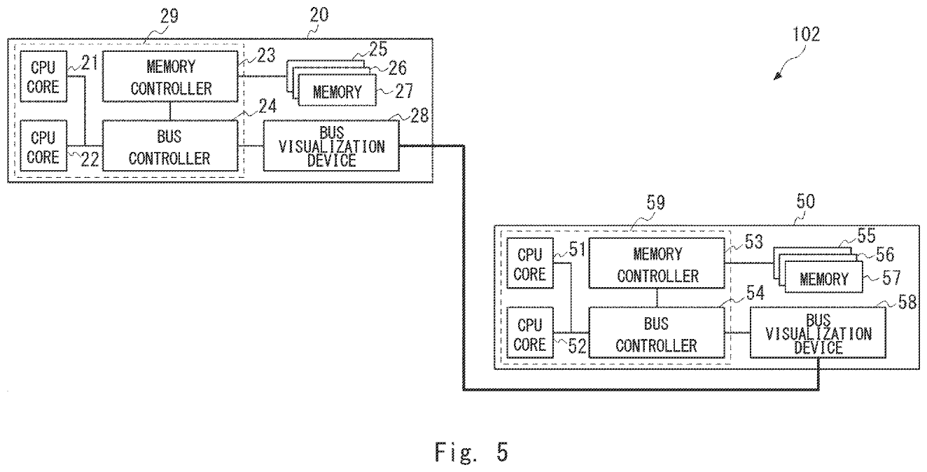

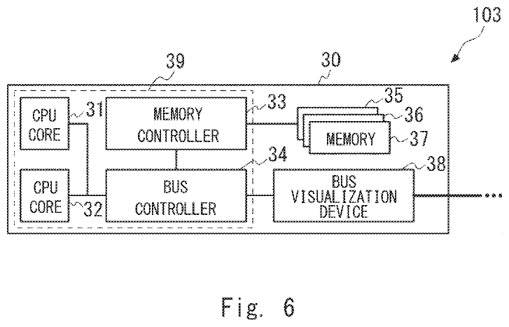

Specific examples of a logical ECU will be described. In these examples, three logical ECUs 101, 102 and 103 are configured. The logical ECU 101 is configured by logically coupling the fixed physical ECU 10 and the additional physical ECU 40. The logical ECU 102 is configured by logically coupling the fixed physical ECU 20 and the additional physical ECU 50. The logical ECU 103 is configured by the fixed physical ECU 30 alone. FIGS. 4 to 6 schematically illustrate a configuration of the logical ECU 101, 102 and 103, respectively.

[Logical ECU 101] The configuration instruction INS1 that is given to the fixed physical ECU 10 includes, as a destination address, an address of the fixed physical ECU 10, and as another destination address, an address of the additional physical ECU 40, that configures, together with the fixed physical ECU 10, a logical ECU. The configuration instruction INS4 that is given to the additional physical ECU 40 includes, as a destination address, the address of the additional physical ECU 40, and as another destination address, the address of the fixed physical ECU 10, that configures, together with the additional physical ECU 40, a logical ECU.

The bus virtualization device 18 of the fixed physical ECU 10 receives the configuration instruction INS1 by referencing a destination address and updates setting information so as to perform communications only with the additional physical ECU 40 specified by another destination address. Similarly, the bus virtualization device 48 of the additional physical ECU 40 receives the configuration instruction INS4 by referencing a destination address and updates setting information so as to perform communications only with the fixed physical ECU 10 specified by another destination address.

This implements the logical ECU 101 that is defined to perform communications only between the fixed physical ECU 10 and the additional physical ECU 40. The CPU cores 11 and 12 can access the memories 45 to 47 in the additional physical ECU 40. The CPU cores 41 and 42 can access the memories 15 to 17 in the fixed physical ECU 10.

### [Logical ECU 102]

The configuration instruction INS2 that is given to the fixed physical ECU 20 includes, as a destination address, an address of the fixed physical ECU 20, and as another destination address, an address of the additional physical ECU 50, that configures, together with the fixed physical ECU 20, a logical ECU. The configuration instruction INS5 that is given to the additional physical ECU 50 includes, as a destination address, the address of the additional physical ECU 50, and as another destination address, the address of the fixed physical ECU 10, that configures, together with the additional physical ECU 50, a logical ECU.

The bus virtualization device 28 of the fixed physical ECU 20 receives the configuration instruction INS2 by referencing a destination address and updates setting information so as to perform communications only with the additional physical ECU 50 specified by another destination address. Similarly, the bus virtualization device 58 of the additional physical ECU 50 receives the configuration instruction INS5 by referencing a destination address and updates setting information so as to perform communications only with the fixed physical ECU 20 specified by another destination address.

This implements the logical ECU 102 that is defined to perform communications only between the fixed physical ECU 20 and the additional physical ECU 50. The CPU cores 21 and 22 can access the memories 55 to 57 in the additional physical ECU 50. The CPU cores 51 and 52 can access the memories 25 to 27 in the fixed physical ECU 20.

### [Logical ECU 103]

The configuration instruction INS3 that is given to the fixed physical ECU 30 includes, as a destination address, an address of the fixed physical ECU 30. As a physical ECU that configures, together with the fixed physical ECU 20, a logical ECU, the home address (that is, the fixed physical ECU 30) is included as another destination address, or another destination address is vacant.

The bus virtualization device 38 of the fixed physical ECU 30 receives the configuration instruction INS3 by referencing a destination address and updates setting information so as to configure the logical ECU 103 with only the home fixed physical ECU (fixed physical ECU 30) by referencing another destination address.

This implements the logical ECU 103 that is defined to include only the fixed physical ECU 30.

While it has been described that a physical ECU communicates only with another physical ECU that cooperates to configure a logical ECU, it is needless to say that a physical ECU performs communications with a unit to be controlled in a vehicle, for example an engine, an air conditioner, a lighting, or a collision prevention device. In other words, it is possible to connect a logical ECU with a device to be controlled, by including an address of a device to be controlled in a configuration instruction that is given to a physical ECU.

Examples of function configuration of a logical ECU will be described. As described above, the logical ECU 101, 102 and 103 are separated from each other by virtualizing an internal bus.

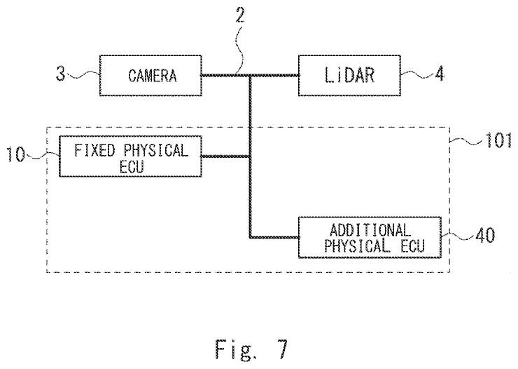

FIG. 7 schematically illustrates a function configuration of the logical ECU 101. The logical ECU 101 controls processing related to automatic driving of a vehicle and is configured to control the camera 3 and the LiDAR 4 in this example.

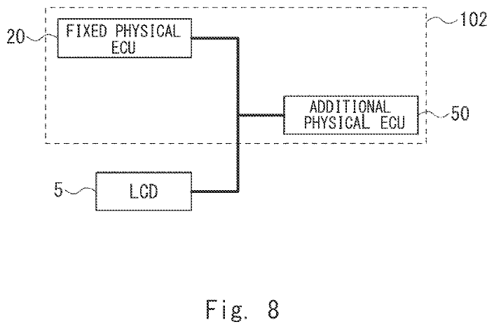

FIG. 8 schematically illustrates a function configuration of the logical ECU 102. The logical ECU 102 controls processing related to IVI (In-Vehicle Infotainment) and is configured to control the LCD 5 in this example.

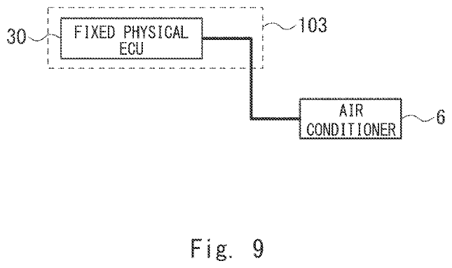

FIG. 9 schematically illustrates a function configuration of the logical ECU 103. The logical ECU 103 controls processing related to air conditioning of a vehicle and configured to control the air conditioner 6 in this example.

As described above, according to this example embodiment, it is possible to configure a logical ECU by virtualizing an internal bus in corresponding with a function provided in a vehicle. This makes it possible to select the number of necessary physical ECUs as appropriate from all the physical ECUs that have been provided, in accordance with a function that is executed by the vehicle control system, thereby configuring a logical ECU. Accordingly, even after shipment of a vehicle, it is possible to flexibly change or expand a function of the vehicle control system.

It is possible to assign one or more functions to a single logical ECU. For example, when a logical ECU includes three physical ECUs (six CPU cores), a function may be assigned to four CPU cores and another function may be assigned to two CPU cores. When a function that requires a high security is included, the function may be split, as appropriate, into a logical ECU including a single physical ECU (two CPU cores) and a logical ECU including two physical ECUs (four CPU cores).

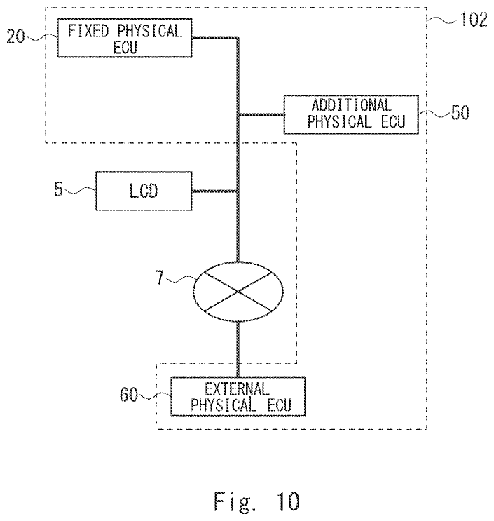

Depending on a function that is assigned to a logical ECU, it is possible to configure a logical ECU including a physical ECU external to a device. FIG. 10 schematically illustrates a configuration assumed when the logical ECU 102 includes an external physical ECU 60. In an IVI system, it is assumed that contents such as a moving picture or music is played and data of a moving picture or music may be provided by a server outside a company. In this case, it is possible to incorporate an external server or a device connected to the external server into a logical ECU that is virtually configured as an external physical ECU thereby expand a configuration of the logical ECU. The fixed physical ECU 20 and the additional physical ECU 40 in a vehicle may continuously perform communications with the external physical ECU 60 via a wireless network, for example.

### Second Example Embodiment

A vehicle control system according to a second example embodiment will be described. A vehicle control system 2000 according to the second example embodiment includes, as with the vehicle control system 1000, a plurality of physical ECUs, across which a virtual ECU is configured.

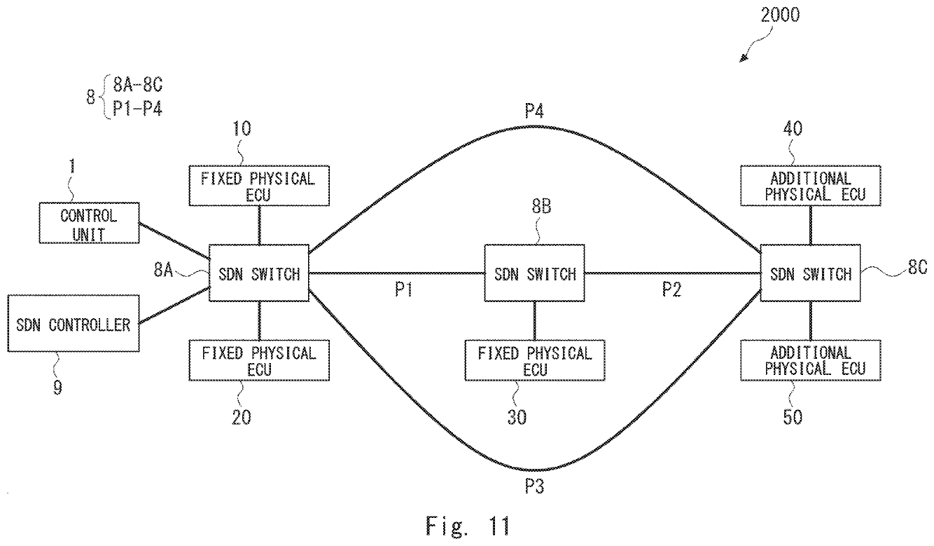

FIG. 11 schematically illustrates a configuration of the vehicle control system 2000 according to the second example embodiment. While the physical ECUs are interconnected via a bus 2 in the vehicle control system 1000, physical ECUs are interconnected via an SDN (Software Defined Network) 8 in the vehicle control system 2000. In the SDN network 8, an SDN controller 9 executes control software or the like to centrally control network devices such as an SDN switch and flexibly changes a network configuration, setting and the like. The SDN controller may have the same configuration as the control unit described with reference to FIG. 3, or may be integral with the control unit 1.

In this example, the SDN network 8 includes SDN switches 8A, 8B and 8C. A fixed physical ECU 10, a fixed physical ECU 20, the control unit 1, and the SDN controller 9 are connected with the SDN switch 8A. The fixed physical ECU 30 is connected with the SDN switch 8B. An additional physical ECU 40 and an additional physical ECU 50 are connected with the SDN switch 8C.

The SDN switch 8A and the SDN switch 8B are interconnected via a path P1. The SDN switch 8B and the SDN switch 8C are interconnected via a path P2. A path including the path P1 and the path P2 is a shortest path that interconnects the SDN switch 8A and the SDN switch 8C.

The SDN switch 8A and the SDN switch 8C are interconnected by a redundant path P3 and a redundant path P4. The redundant path P3 and the redundant path P4 have a longer path length compared with the shortest path including the path P1 and the path P2, and are provided to address, for example, a fault that a path may encounter.

Next, a path that interconnects physical ECUs in a logical ECU will be described. In the following description, it is assumed that the logical ECU 101 controls a device having a high priority such as an engine and that the logical ECU 102 controls a device having a lower priority such as an air conditioner.

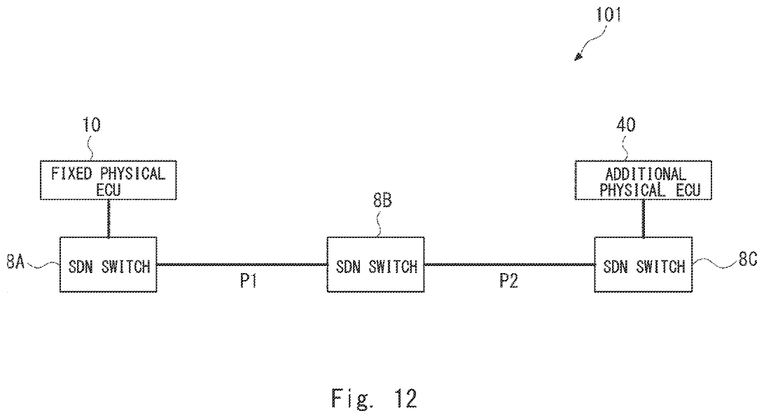

In this example, the SDN controller 9 controls the SDN switches 8A, 8B and 8C so that a fixed physical ECU 10 and an additional physical ECU 40 in the logical ECU 101 will be interconnected via the shortest paths P1 and P2. FIG. 12 schematically illustrates a configuration of the logical ECU 101 according to the second example embodiment. This configuration interconnects, via the shortest path, physical ECUs in the logical ECU 101 having a high priority for the purpose of assuring a vehicle function.

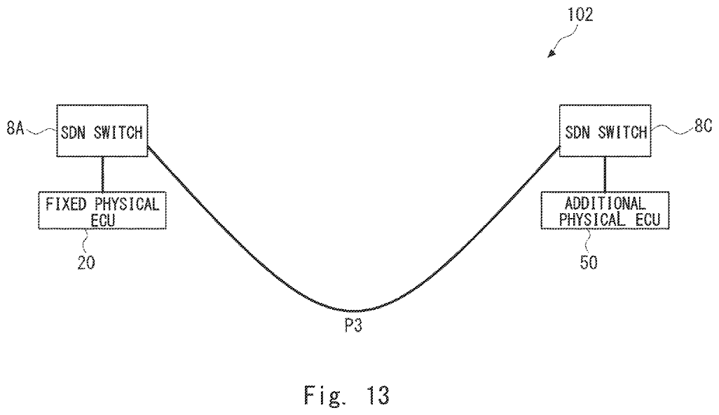

The SDN controller 9 controls the SDN switches 8A and 8C so that the fixed physical ECU 20 and the additional physical ECU 50 in the logical ECU 102 will be interconnected via the redundant path P3. FIG. 13 schematically illustrates a configuration of the logical ECU 102 according to the second example embodiment. This configuration interconnects, via the redundant path, physical ECUs in the logical ECU 102 having a lower priority for the purpose of assuring a vehicle function.

According to this configuration, it is possible to assign a dedicated path to the logical ECU 101 and the logical ECU 102, thus reliably separating the logical ECU 101 from the logical ECU 102.

According to this configuration, it is possible to physically define a communication path between physical ECUs by using an SDN switch. Intervention of an SDN switch prevents an access to a logical ECU from outside. This is advantageous in that it is possible to implement a vehicle control system that requires a high security to prevent an illegal access such as hacking.

### Third Example Embodiment

A vehicle control system according to a third example embodiment will be described. In a vehicle such as an automobile, it can be assumed that control of an in-vehicle device is switched depending on a state of the vehicle. In this example embodiment, a configuration of a logical ECU in accordance with a state of a vehicle will be described.

In this example embodiment, states of a vehicle include a vehicle driving state and a driving mode.

The vehicle driving state refers to a vehicle halting state or a vehicle traveling state. The driving mode refers to an automatic driving mode or a manual driving mode.

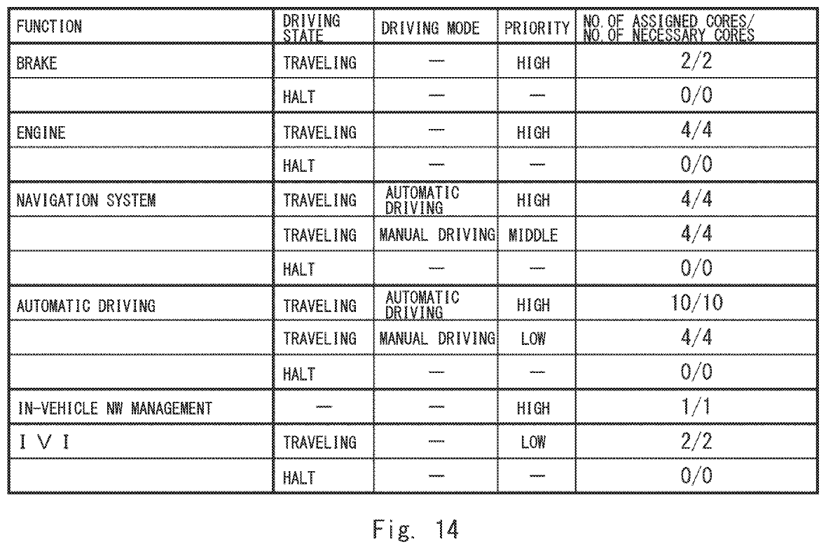

FIG. 14 schematically illustrate an example of a configuration table in the vehicle control system. This configuration table indicates a state of a brake, an engine, a navigation system, an automatic driving system. a corporate network (NW) system and an IVI (In-Vehicle Infotainment) system, as well as priorities in each driving mode and the number of necessary CPU cores.

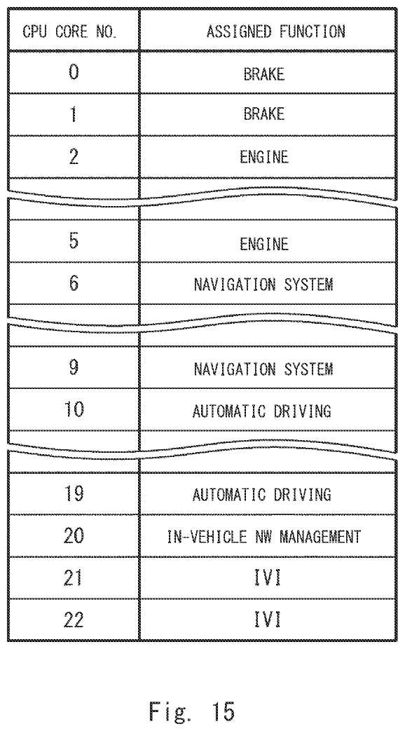

FIG. 15 schematically illustrates an assignment table of a CPU core in the vehicle control system. This assignment table indicates which functions the CPU cores in the vehicle in the physical ECU control system are currently assigned to. In this example, 22 CPU cores are provided in the vehicle control system.

When a state of a vehicle has changed, the vehicle control system changes an assignment of a physical ECU based on the above configuration table and assignment table, and, as described in the first and second example embodiments, in accordance with the change, interconnects the number of necessary physical ECUs so that the number of necessary CPU cores will be assigned to a particular function to configure the logical ECU. The configuration table and the assignment table are stored, for example, in a memory 11B in FIG. 3, loaded by a processor 11A, and then analyzed.

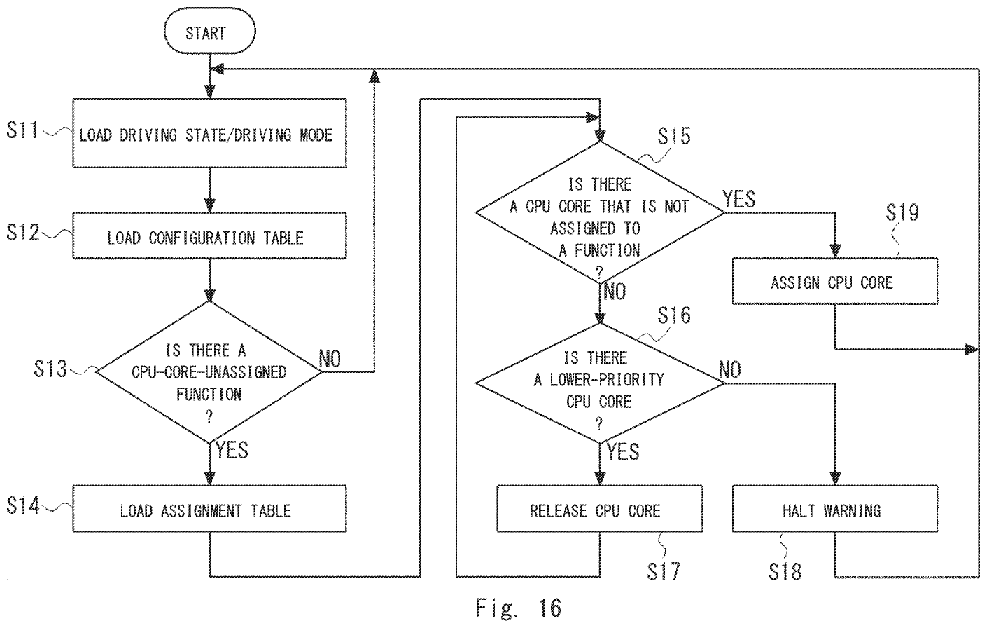

Assignment of a CPU core in the third example embodiment will be described. FIG. 16 illustrates a flowchart of assignment processing of a CPU core in the third example embodiment.

### Step S11

The control unit 1 loads a state of a vehicle (a driving state and a driving mode).

### Step S12

The control unit 1 loads the configuration table and identifies the number of CPU cores to be assigned to a function, based on the state of the vehicle (the driving state and the driving mode) that has been loaded.

### Step S13

The control unit 1 determines whether there is a function to which no CPU cores have been assigned. When there is a function to which no CPU cores have been assigned, the control unit 1 returns to the step S11 and continues monitoring the state of the vehicle.

### Step S14

When there is a function to which no CPU cores have been assigned, the control unit 1 loads the assignment table.

### Step S15

The control unit 1 determines whether the assignment table includes a CPU core that has not been assigned to a particular function.

### Step S16

When there are no CPU cores that have been assigned, the control unit 1 determines whether a CPU core has been assigned to a function having a lower priority than the assignment-target function.

### Step S17

When it is determined in the step S16 that a CPU core has been assigned to a function having a lower priority, the control unit 1 releases the CPU core. The control unit 1 may notify a display device such as the above-mentioned LCD that a function corresponding to the released CPU core has stopped. This causes the display unit to display that the function has stopped. The control unit 1 returns the processing to the step S15.

### Step S18

When it is determined in the step S16 that no CPU cores have been assigned to a function having a lower priority, no CPU cores exist that can be released. Thus, it is impossible to prepare a required number of CPU cores in the configuration table. In this case, the control unit 1 outputs, for example as a fault warning, information to a display unit or the like that the control unit 1 cannot configure a logical ECU. Then, the control unit 1 returns to the step S11 and continues monitoring the state of the vehicle.

### Step S19

When there is a CPU core that has not been assigned to a particular function, the control unit 1 assigns the CPU core as a CPU core requested by a function in the configuration table. Then, the control unit 1 returns to the step S11 and continues monitoring the state of the vehicle.

As described above, according to this configuration, when configuring a logical ECU, the control unit 1 can assign the number of necessary CPU cores for a required function in accordance with a driving state or a driving mode of a vehicle. This makes it possible to implement a logical ECU that can suitably assure a function of a vehicle.

### Fourth Example Embodiment

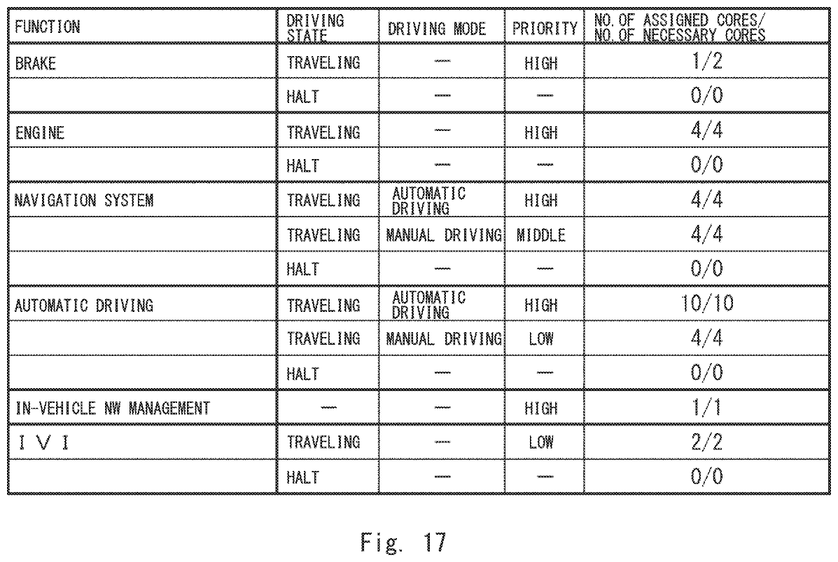

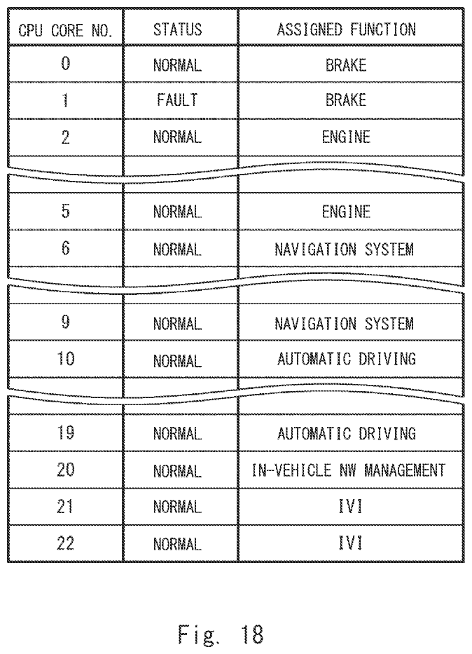

A vehicle control system in accordance with a fourth example embodiment will be described. The vehicle control system in accordance with the fourth example embodiment is a variant of the vehicle control system in accordance with the third example embodiment, and is configured as a vehicle control system that can address a fault in a physical ECU. In this example embodiment, the assignment table includes information indicating presence/absence of a fault in a physical ECU. FIG. 17 schematically illustrates an assignment table in the vehicle control system in accordance with the fourth example embodiment. FIG. 18 schematically illustrates a CPU core assignment table in the vehicle control system in accordance with the fourth example embodiment.

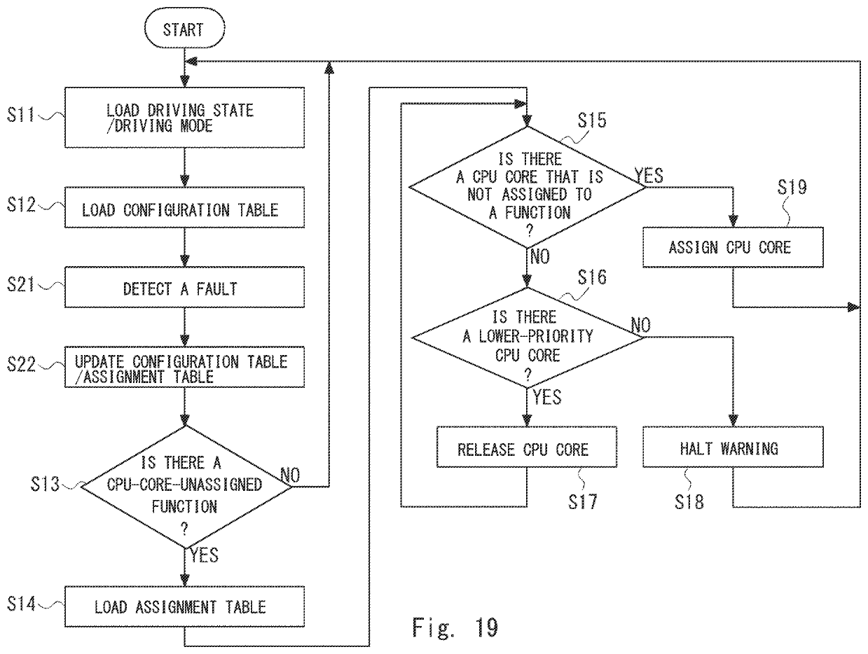

In this example embodiment, the vehicle control system updates a configuration table and an assignment table depending on a fault occurring in a physical ECU and assigns, among available physical ECUs, a physical ECU to be assigned to a function. Assignment of a physical ECU in the fourth example embodiment will be described. FIG. 19 illustrates a flowchart of assignment of a CPU core in the fourth example embodiment.

The steps S11 to S19 are the same as those in FIG. 16 and thus the description thereof will be omitted herein. Additional steps S21 and S22 will be described. The Steps S21 and S22 are inserted between the step S12 and the step S13.

### Step S21

The control unit 1 checks a state of a physical ECU and determines presence/absence of a fault. The control unit 1 transmits a response request signal, for example, to a physical ECU. The physical ECU, receiving a response request signal, transmits a response signal to the control unit 1. A faulty ECU cannot transmit a response signal. Accordingly, when a response signal is not returned from a physical ECU, the control unit 1 can determine that the physical ECU is faulty. A physical ECU may include a self-diagnosis function and autonomously detect a fault and notify the fault to the control unit 1.

### Step S22

The control unit 1, detecting a fault in a physical ECU, subtracts the number of faulty CPU cores of a physical ECU from the number of all the CPU cores assigned to a function in the configuration table. Then, the control unit 1 changes a status of a relevant physical ECU in the assignment table. In FIG. 17, by way of an example, assuming that a CPU core of a physical ECU assigned to a brake is faulty, an assigned CPU core count is reduced from two (in FIG. 14) to one.

In this way, in the next step S13, one or more faulty CPU cores are excluded from CPU cores counted as being assigned to a function. Thus, resulting CPU cores in need can be assigned in the step S14 or later.

In the step S15, a CPU core whose status is faulty is handled as an unassigned CPU core, which prevents a faulty CPU from being erroneously assigned to a function.

According to this configuration, even when a physical ECU (CPU core) has become faulty, it is possible to exclude the faulty physical ECU (CPU core) and appropriately configures a logical ECU. This maintains functions of a vehicle control system while providing as many physical ECUs (CPU cores) as required for functions in priority order.

### Fifth Example Embodiment

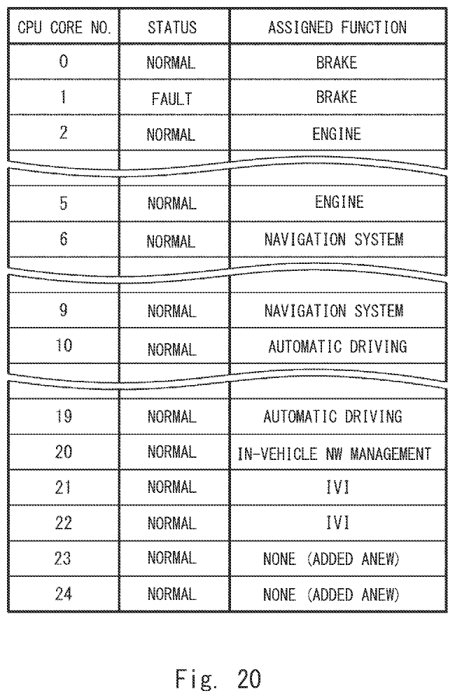

As described in the first example embodiment, an additional physical ECU may be retrofitted to a vehicle as a target of control by a vehicle control system. In this case, it is necessary to reflect this change on the additional physical ECU that has been added to the assignment table described in the fourth and fifth example embodiments. Processing to reflect an additional physical ECU that has been added on the assignment table according to this example embodiment will be described. FIG. 20 schematically illustrates a CPU core assignment table in a vehicle control system according to the fifth example embodiment. In FIG. 20, CPU cores numbered 23 and 24 are those CPU cores of a physical ECU that have been added anew.

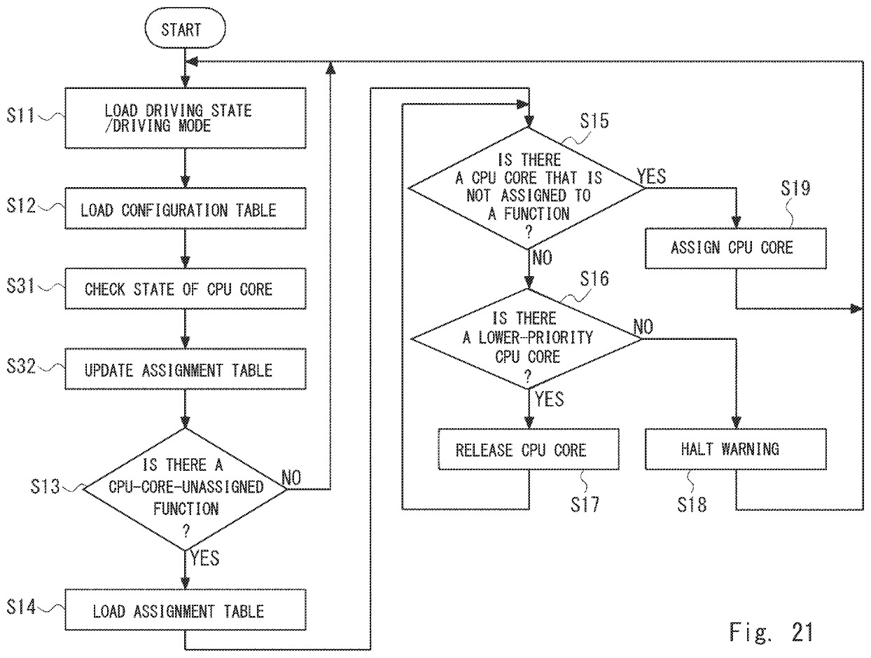

FIG. 21 illustrates a flowchart of CPU core assignment processing in the fifth example embodiment. The steps S11 to S19 are the same as those in FIG. 16 and thus the description thereof will be omitted herein. Additional steps S31 and S32 will be described. The steps S31 and S32 are inserted between step the S12 and step the S13.

### Step S31

The control unit 1 checks a state of an added CPU core of the additional physical ECU. The control unit 1 transmits a response request signal, for example, to the additional physical ECU that has been added. The additional physical ECU that has been added, receiving a response request signal, may transmit a response signal to the control unit 1. An additional physical ECU may include a plug-and-play function and autonomously notify its state to the control unit 1.

### Step S32

The control unit 1 adds, to the assignment table, an added CPU core of the additional physical ECU.

Accordingly, in the step S15, the added CPU core of the additional physical ECU becomes an unassigned CPU core. It is thus possible to assign the CPU core anew to a function.

According to this configuration, even when an additional physical ECU has been added, it is possible to reflect the added ECU in a CPU core assignment process. This makes it possible to add a physical ECU as appropriate, thereby expanding functions of a vehicle control system on an as-needed basis.

### Other Example Embodiments

The invention is not limited to the above example embodiments but may be changed as appropriate within the scope thereof. For example, while a bus virtualization device has been described as being provided inside a physical ECU but may be provided outside a physical ECU as a target of communication control.

The number of CPU cores or memories in a physical ECU is not limited to that of the aforementioned examples, but may be any number. A configuration of a physical ECU provided in a vehicle control system may be the same or different.

While a logical ECU has been described as including one or two physical ECUs in the above example embodiments, a logical ECU may include three or more physical ECUs.

While the above SDN network has been described as including three SDN switches and four paths, an SDN network including another configuration may be used instead.

As described above, an example of a hardware configuration of the control unit 1 has been described in the above example embodiments, the configuration is not limited thereto. Any processing of the control unit 1 may be attained by causing a CPU (Central Processing Unit) to execute a computer program. The above program can be stored by using various types of non-transitory computer readable media and provided to a computer. The non-transitory computer readable media include various types of tangible storage media. Examples of the non-transitory computer readable media include a magnetic recording medium such as a flexible disk, a magnetic tape or a hard disk drive, a magneto-optical medium such as a magneto-optical disk, a CD-ROM (Read Only Memory), a CD-R, a CD-R/W, and a semiconductor memory such as a mask ROM, a PROM (Programmable ROM), an EPROM (Erasable PROM), a flash ROM or a RAM (Random Access Memory). The program may be provided to a computer by various types of transitory computer readable media. Examples of the transitory computer readable media include an electric signal, an optical signal, and an electromagnetic wave. The transitory computer readable media is capable of providing a program to a computer via a wired communication path such as an electric wire and an optical fiber, or a wireless communication path.

A part of or all of the above-described example embodiments can be described as in the following supplementary notes. However, the present invention is not limited to the following supplementary notes.

### (Supplementary Note 1)

A vehicle control system including: a plurality of physical ECUs that control operation of a device installed in a vehicle; a plurality of bus virtualization devices that respectively control communications of the plurality of physical ECUs; and a control unit that, in order to configure one or more logical ECUs that perform communications only between physical ECUs selected from the plurality of physical ECUs, controls bus virtualization devices corresponding to the selected physical ECUs.

### (Supplementary Note 2)

The vehicle control system according to Supplementary note 1, wherein the plurality of physical ECUs include a fixed physical ECU installed in the vehicle and an additional physical ECU retrofitted to the vehicle.

### (Supplementary Note 3)

The vehicle control system according to Supplementary note 2, wherein the plurality of physical ECUs further include an external physical ECU configured to be communicable with another physical ECU and disposed outside the vehicle.

### (Supplementary Note 4)

The vehicle control system according to any one of Supplementary notes 1 to 3, wherein the bus virtualization device is provided in the corresponding physical ECU or provided as a separate device from the corresponding physical ECU.

### (Supplementary Note 5)

The vehicle control system according to any one of Supplementary notes 1 to 4, wherein the plurality of bus virtualization devices and the control unit are interconnected via a common bus, and the one or more logical ECUs are configured by the one of more physical ECUs that are interconnected via the common bus.

### (Supplementary Note 6)

The vehicle control system according to any one of Supplementary notes 1 to 4, further including an SDN network including SDN switches and an SDN controller that controls the SDN switches, wherein the plurality of bus virtualization devices and the control unit are interconnected via the SDN network, and the one or more logical ECUs are configured by the one of more physical ECUs that are interconnected via the SDN network.

### (Supplementary Note 7)

The vehicle control system according to Supplementary note 6, wherein, when at least two logical ECUs are configured, the SDN controller controls the SDN switches so that communication paths of the logical ECUs will be separated from each other.

### (Supplementary Note 8)

The vehicle control system according to Supplementary note 7, wherein the SDN controller controls the SDN switches so that, the higher priority the logical ECU has, the shorter the path between the included physical ECUs will become.

### (Supplementary Note 9)

The vehicle control system according to any one of Supplementary notes 1 to 8, wherein the control unit determines, depending on a state of the vehicle, functions to which physical ECUs need to be assigned and the number of the physical ECUs required by the functions to which physical ECUs need to be assigned, and determines, among the available physical ECUs, physical ECUs to be assigned to the functions to which physical ECUs need to be assigned, thereby configuring the logical ECU.

### (Supplementary Note 10)

The vehicle control system according to Supplementary note 9, wherein the control unit assigns, depending on a state of the vehicle, the as many physical ECUs as required, to functions to which physical ECUs need to be assigned, in priority order thereof.

### (Supplementary Note 11)

The vehicle control system according to Supplementary note 9 or 10, wherein the control unit, detecting a faulty physical ECU among the plurality of physical ECUs, excludes the faulty physical ECU from the available physical ECUs.

### (Supplementary Note 12)

The vehicle control system according to any one of Supplementary notes 9 to 11, wherein, when a physical ECU is added to the vehicle anew, the control unit adds the additional physical ECU to the available physical ECUs.

### (Supplementary Note 13)

A vehicle control method including: in order to configure one or more logical ECUs that perform communications only between physical ECUs selected from a plurality of physical ECUs that control operation of a device installed in a vehicle, selecting physical ECUs that configure the one or more logical ECUs, and controlling a plurality of bus virtualization devices, corresponding to the selected physical ECUs, that respectively control communications of the plurality of physical ECUs.

### (Supplementary Note 14)

A vehicle control program that causes a computer to execute: in order to configure one or more logical ECUs that perform communications only between physical ECUs selected from a plurality of physical ECUs that control operation of a device installed in a vehicle, processing to select physical ECUs that configure the one or more logical ECU, and processing to control a plurality of bus virtualization devices, corresponding to the selected physical ECUs, that respectively control communications of the plurality of the physical ECUs.

While the invention of the application has been described above with reference to the example embodiments, the invention is not limited by the above-described example embodiments. Various changes that may be understood by a person skilled in the art can be made to a configuration and details of the invention of the application within the scope of the invention.

This application claims the benefit of priority that is based upon Japanese Patent Application No. 2019-46463, filed on Mar. 13, 2019, the disclosure of which is incorporated herein in its entirety by reference.

### REFERENCE SIGNS LIST

1 CONTROL UNIT
1A PROCESSOR
1B MEMORY
1C INPUT/OUTPUT INTERFACE
1D PERIPHERAL CIRCUIT
1E BUS
2 BUS
3 CAMERA
4 LiDAR
5 LCD
6 AIR CONDITIONER
8 SDN NETWORK
8A-8C SDN SWITCH
9 SDN CONTROLLER
10, 20, 30 FIXED PHYSICAL ECU
11, 12, 21, 22, 31, 32, 41, 42, 51, 52 CPU CORE
13, 23, 33, 43, 53 MEMORY CONTROLLER
14, 24, 34, 44, 54 BUS CONTROLLER
15-17, 25-27, 35-37, 45-47, 55-57 MEMORY
18, 28, 38, 48, 58 BUS VIRTUALIZATION DEVICE
19, 29, 39, 49, 59 IC PACKAGE
40, 50 ADDITIONAL PHYSICAL ECU
60 EXTERNAL PHYSICAL ECU
101, 102, 103 LOGICAL ECU
1000, 2000 VEHICLE CONTROL SYSTEM
P1, P2 PATH
P3, P4 REDUNDANT PATH

What is claimed is:

1. A vehicle control system comprising:
a plurality of physical ECUs that control operation of a device installed in a vehicle;
a plurality of bus virtualization devices that respectively control communications of the plurality of physical ECUs; and
a control unit that, in order to configure one or more logical ECUs that perform communications only between physical ECUs selected from the plurality of physical ECUs, controls bus virtualization devices corresponding to the selected physical ECUs.

2. The vehicle control system according to claim 1, wherein the plurality of physical ECUs comprise a fixed physical ECU installed in the vehicle and an additional physical ECU retrofitted to the vehicle.

3. The vehicle control system according to claim 2, wherein the plurality of physical ECUs further comprise an external physical ECU configured to be communicable with another physical ECU and disposed outside the vehicle.

4. The vehicle control system according to claim 1, wherein the bus virtualization device is provided in the corresponding physical ECU or provided as a separate device from the corresponding physical ECU.

5. The vehicle control system according to claim 1, wherein
the plurality of bus virtualization devices and the control unit are interconnected via a common bus, and
the one or more logical ECUs are configured by the one of more physical ECUs that are interconnected via the common bus.

6. The vehicle control system according to claim 1, further comprising an SDN network including SDN switches and an SDN controller that controls the SDN switches, wherein
the plurality of bus virtualization devices and the control unit are interconnected via the SDN network, and
the one or more logical ECUs are configured by the one of more physical ECUs that are interconnected via the SDN network.

7. The vehicle control system according to claim 6, wherein, when at least two logical ECUs are configured, the SDN controller controls the SDN switches so that communication paths of the logical ECU will be separated from each other.

8. The vehicle control system according to claim 1, wherein the control unit determines, depending on a state of the vehicle, functions to which physical ECUs need to be assigned and the number of the physical ECUs required by the functions to which physical ECUs need to be assigned, and determines, among the available physical ECUs, physical ECUs to be assigned to the functions to which physical ECUs need to be assigned, thereby configuring the logical ECU.

9. A vehicle control method comprising: in order to configure one or more logical ECUs that perform communications only between physical ECUs selected from a plurality of physical ECUs that control operation of a device installed in a vehicle,
selecting physical ECUs that configure the one or more logical ECUs; and
controlling a plurality of bus virtualization devices, corresponding to the selected physical ECUs, that respectively control communications of the plurality of physical ECUs.

10. A non-transitory computer readable medium in which a vehicle control program is stored that causes a computer to execute: in order to configure one or more logical ECUs that perform communications only between physical ECUs selected from a plurality of physical ECUs that control operation of a device installed in a vehicle,
processing to select physical ECUs that configure the one or more logical ECUs; and
processing to control a plurality of bus virtualization devices, corresponding to the selected physical ECUs, that respectively control communications of the plurality of the physical ECUs.
